(19) United States
(12) Patent Application Publication
(10) Pub. No.: US 2004/0264834 A1
(43) Pub. Date: Dec. 30, 2004

(54) Feedback controlled photonic frequency selection circuit

(76) Inventors: Thomas J. McIntyre, Nokesville, VA (US); Charles N. Alcorn, Centreville, VA (US)

Correspondence Address: BAE SYSTEMS INFORMATION AND, ELECTRONIC SYSTEMS INTEGRATION INC., 65 SPIT BROOK ROAD, P.O. BOX 868 NHQ1-719, NASHUA, NH, 03061-0868, US

(21) Appl. No.: 10/608,169

(22) Filed: Jun. 26, 2003

(51) Int. Cl. G02B 6/12

(52) U.S. Cl. 385/14

(57) ABSTRACT

A photonic circuit with the ability to precisely select a frequency is disclosed. The temperature of a resonator in the circuit is monitored by a sensor. Data regarding the resonator's temperature is transmitted to a processor. The processor either energizes or varies the amount of current to a heater element that maintains the temperature of the resonator at a precise level. By precisely maintaining the temperature of the resonator, the refractive index of the resonator can be precisely maintained, and a particular frequency of light can be selected. By the same token, by precisely changing the temperature of the resonator, the circuit can be variably tuned to select any frequency of light.

### FIELD OF THE INVENTION

The present invention relates to photonic circuits and resonators of such circuits, and in particular, circuits and resonators that can be variably tuned to select or filter a spectrum of light frequencies.

### BACKGROUND OF THE INVENTION

Integrated photonic devices with resonators are used in fiber optic communication networks. These networks use optical data signals that are transported from one location to the next and/or modified prior to their use by other photonic devices. In particular, photonic devices can be used as switches to select a particular frequency of light (or by default to filter out unwanted frequencies of light). Used as a switch, a photonic resonator can be turned on, i.e. permit the passage of light of a certain frequency, or turned off, i.e. not allow the passage of light of a certain frequency (or light of any frequency). The frequency that is selected by a photonic device depends on factors such as the size of the resonator, its refractive index, and the temperature of the resonator. Indeed, photonic resonators can be made to turn on and off depending upon heating from a nearby heat source or cooling from a source such as an in-situ Peltier device. A built-in thermoelectric cooling mechanism (Peltier device) is disclosed in U.S. Pat. No. 6,559,538 which issued May 6, 2003 to Pomerene et al. and is commonly owned along with the present application, the teaching of which are hereby incorporated by reference. The photonic device can be mounted on a heat sink so that current could always be flowing to the heaters to keep the photonic device above ambient with the current varied to maintain the photonic device at a set temperature. The application of heat to a photonic resonator causes the refractive index of that resonator to change so that the switch no longer picks up or resonates at the desired frequency.

What is absent from the present state of the art is a photonic device that acts not only as a switch that can be turned on and off thereby allowing a particular frequency of light to be added or dropped, but that functions as an infinitely variable tunable device that is precisely controlled to select a particular frequency dependant upon the precise temperature of the resonator. The present invention addresses that absence.

### SUMMARY OF THE INVENTION

The present invention is a photonic circuit with a feedback loop that permits the infinitely variable fine tuning of frequencies that are added and/or dropped by the circuit.

The photonic circuit has a resonator of a certain size, shape, and refractive indices at particular temperatures. A sensor positioned near the resonator monitors the temperature of the resonator. The sensor can be something as simple as a metal wire. Any temperature change of the resonator is detected by a change in resistance of the sensor. This change is transmitted to a processor that alters the level of current supplied to a heater element positioned near the resonator. The energizing or variation of the amount of current through the heater element maintains the temperature of the resonator, and the specific frequency that it is selecting, at the desired value.

It is therefore an object of a preferred embodiment of the present invention to selectively tune frequencies that are added and/or dropped by a resonator in a photonic circuit.

It is another object of a preferred embodiment of the present invention to increase the flexibility and the effective density of photonic circuits.

### BRIEF DESCRIPTION OF THE DRAWING

FIG. 1 illustrates the feedback controlled selection circuit for a photonic device of the present invention.

### DETAILED DESCRIPTION OF THE INVENTION

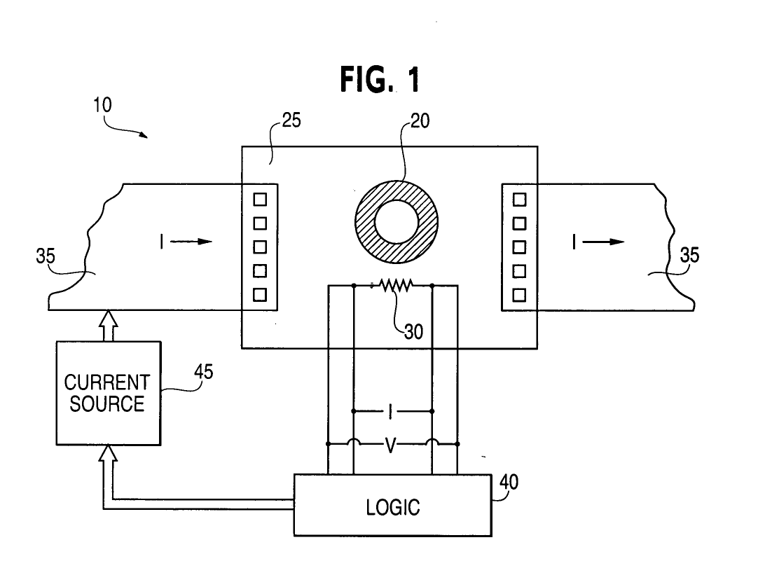

The present invention is a photonic circuit that can infinitely variably select frequencies of light through the precise control of the temperature of a resonator by a temperature feedback control circuit. In a preferred embodiment of the invention, the circuit is microphotonic in nature, and etched onto an integrated circuit. An embodiment of the circuit of the present invention is illustrated in FIG. 1.

Referring to FIG. 1, a photonic circuit 10 has a resonator 20. In the preferred embodiment, the circuit 10 and its components are etched onto a substrate 25 using standard microphotonic processing techniques. The substrate 25 is heated by element 35. As in other photonic circuits, the resonator 20 has input and output waveguides, however, since the invention can be adequately explained without the presence of waveguides, the waveguides are not pictured in FIG. 1. Located near the resonator 20 is a temperature sensor 30. The temperature sensor 30 can be something as simple as an aluminum wire. A current is supplied to and runs through the sensor 30, and the voltage across the sensor 30 is measured. In a preferred embodiment, the voltage is measured using a Kelvin connection so as to avoid the problems of contact resistances and voltmeter internal resistances. The Kelvin connection communicates with processor 40, which in turn communicates with current source 45. Current source 45 supplies a current to heater element 35 thereby energizing that element.

As referred to in the previous paragraph, the photonic resonator 20 of the present invention can be manufactured using standard microphotonic processing techniques. Additionally, the manufacturing process can make any combination of size, shape and refractive index of the resonator as those features are not germane to the invention. That is, the present invention encompasses any type of resonator and heater design or material.

The sensor 30 (also referred to as a feedback element) can be patterned at the same time as the heater element 35. The two elements can be made out of the same material or fabricated separately with different materials. If patterned at the same time, the heater element 35 and sensor 30 should be wired on separate loops and separated in the horizontal x-y plane. However, it is preferred that the heater element 35 and the sensor 30 are equidistant from the resonator and manufactured out of the same material. If not equidistant and not of the same material, the control algorithm of the processor 40 should account for this. While the heater element 35 and sensor 30 may be equidistant from the resonator 20, they should be separated from the optical elements with a layer of passivation so as to avoid optical coupling. Additionally, the sensor 30 may be patterned so that the portion of the sensor that is proximate to heater 35 necks down to micron or even submicron levels in order to be positioned very near the resonator 20. In a preferred embodiment, the passivation is planarized with either reflow, etch or chemical/mechanical processing techniques.

After passivation, a layer of conductor is put down over the resonator 20, heater element 35, and sensor 30. In one embodiment, the conductor layer is 5,000 A sputtered aluminum with 0.5% copper. The conductor is patterned, and then etched by way of standard microlithography and etching techniques. After that, another passivation layer is put down over the conductor layer. For this layer, 3 microns of plasma enhanced chemical vapor disposition (PECVD) tetraethoxysilane (TEOS) can be used. Other plasma deposited oxide known in the art may be used. At this point, the developing chip is put through another round of patterning and etching to open up holes or vias through the passivation layer so that bond pads are opened and the heater element 35 and sensor 30 can be connected to the drive circuitry of the chip.

The heater element 35 and/or substrate 25 can either be over or under the entire resonator 20. The sensor 30 can be over the heater element 35. If the sensor 30 is over the heater element 35, the heater element 35 and sensor 30 are put down and patterned in separate steps with passivation in between the conductive layers. If the chip is manufactured in this manner, the heater element 35 and sensor 30 can be made out of different materials.

Operation of the photonic frequency selection circuit 10 is based on the principle of precise predictable changes in refractive index of the resonator 20 with changes in temperature of the resonator 20. That is, as heat is supplied to the substrate 25 via heating element 35 (or as heat is withheld from the substrate 25 by withholding current from element 35), the temperature of the resonator is likewise altered, as is its refractive index. Specifically, the fine tuning of the temperature of the resonator 20 changes its refractive index to a precise value that then picks off a specific frequency. The sensor 30, which in one embodiment can be a sensing resistor such as a segment of aluminum, acts as a thermometer. A simple aluminum wire is preferred for a sensor 30 since its temperature coefficient of resistance is well defined and its resistance changes linearly with temperature.

The temperature of the resonator is monitored by the sensor 30. A current of known magnitude is run through sensor 30, and a voltage reading is taken at the Kelvin connections across the sensor 30. A resistance is calculated from the known current and voltage reading, and routed back to the processor 40. In the case of a simple metal resistor, a baseline resistance of the sensor 30 at room temperature is determined. The simple metal has a well-defined temperature coefficient of resistance (TCR). TCR is usually expressed as a percent change in resistance per degree Celsius (%/° C.). Any percent change in resistance can be translated into a temperature change. The change in resistance is transmitted to the processor 40, which alters the current supplied to the heater until the requested temperature change in the metal is reached. TCRs for various materials are well documented. Additionally, processor 40 can be loaded with algorithms that identify the temperature change that corresponds to the measured resistance change, and the frequency of light that will be propagated at that temperature by the resonator 20. Consequently, the temperature of the resonator 20 can be precisely controlled in a deliberate step manner through the heater element 35, the sensor 30, and the feedback loop and logic of the processor 40. By precisely controlling the temperature of the resonator 20, a particular frequency of light can be selected in a deliberate step manner. The ability to precisely alter the temperature of the resonator 20 in a deliberate step manner over a range of temperatures permits the resonator 20 to function as a variable tunable switch, thereby making a range of corresponding frequencies available for selection.

While the invention has been described in its preferred embodiment, it is to be understood that the words used are words of description rather than limitation and that changes may be made within the purview of the appended claims without departing from the true scope and spirit of the invention in its broader aspects.

1. A photonic circuit comprising:
a resonator;
means for heating said resonator;
means for measuring a temperature of said resonator; and
means for coupling said temperature measuring means to said heating means;
wherein said temperature measuring means monitors said temperature of said resonator and transmits signals to said heating means based on said temperature; and further
wherein said heating means is enabled or disabled so that said resonator is maintained at a precise temperature and selectively filters a frequency of light corresponding to said temperature.

2. The photonic circuit according to claim 1, wherein said resonator, said heating means, said temperature measuring means, and said coupling means are etched onto an integrated circuit chip.

3. The photonic circuit according to claim 1, wherein said temperature of said resonator is varied over a range of temperatures, thereby causing said resonator to selectively add and drop frequencies corresponding to said temperatures, and wherein said photonic circuit further comprises means to process said selected frequencies.

4. The photonic circuit according to claim 1, wherein said circuit is used as an accurate control for photonic switching.

5. The photonic circuit according to claim 1, wherein said temperature measuring means comprise an aluminum wire.

6. The photonic circuit according to claim 1, wherein said coupling means comprise a processor.

7. A process to variably tune a frequency selected by a photonic resonator comprising the steps of:
identifying a frequency to be selected by said photonic resonator;
sensing a temperature of said photonic resonator;
transmitting a measure of said temperature to a processor;
determining whether said temperature of said photonic resonator corresponds to said selected frequency; and
adjusting said temperature of said photonic resonator to correspond with said selected frequency.

8. The process to variably tune a frequency selected by a photonic resonator according to claim 7, wherein said temperature is sensed by a change in resistance of a metal wire.

9. The process to variably tune a frequency selected by a photonic resonator according to claim 8, wherein said metal wire comprises aluminum.

10. The process to variably tune a frequency selected by a photonic resonator according to claim 9, further comprising the steps of:
measuring a resistance of said wire at room temperature;
increasing resonator temperature by forcing a current though the said wire;
determining the temperature of said photonic resonator during operation by measuring the resistance of the wire at this temperature.

11. The process to variably tune a frequency selected by a photonic resonator according to claim 8, further comprising the steps of:
transmitting a current through said wire;
connecting a volt meter to said wire;
measuring a voltage across said wire; and
calculating the resistance of said wire.

12. The process to variably tune a frequency selected by a photonic circuit according to claim 11, wherein said volt meter is connected to said wire via a Kelvin connection.

13. The process to variably tune a frequency selected by a photonic resonator according to claim 7, wherein said measure of temperature is used as a key into a lookup table, said lookup table comprising different frequencies selected by said resonator at different temperatures.

14. A process to manufacture an integrated photonic resonator circuit, said circuit comprising means to variably tune said resonator to a selectable frequency, comprising the steps of:
etching onto a substrate a photonic resonator;
patterning a sensor element onto said circuit;
placing a first passivation layer over said sensor element;
patterning a beating element onto said circuit;
placing a second passivation layer over said heating element;
placing down a conductor layer, patterning said conductor layer, and etching said conductor layer;
placing a third passivation layer over said conductor layer; and
patterning and etching said circuit, said patterning and etching opening up holes through said passivation layer to expose said heating and sensor elements, and connecting said heating and sensor elements to drive circuitry in said circuit.

15. The process to manufacture an integrated photonic resonator circuit according to claim 14, wherein said sensor element is patterned onto a first plane of said circuit, and said heating element is patterned onto a second plane of said circuit.

16. The process to manufacture an integrated photonic resonator circuit according to claim 14, wherein said sensor element is necked down to micron or submicron levels.

17. The process to manufacture an integrated photonic resonator circuit according to claim 14, wherein said sensor element and said heater element are positioned equidistantly from said resonator.

18. The process to manufacture an integrated photonic resonator circuit according to claim 14, wherein said passivations are planarized with reflow, etch, or chemical/mechanical processing techniques.

19. The process to manufacture an integrated photonic resonator circuit according to claim 14, wherein said conductor is 5,000 A sputtered aluminum with 0.5% copper.

20. The process to manufacture an integrated photonic resonator circuit according to claim 14, wherein said third passivation layer comprises 3 microns of plasma enhanced chemical vapor disposition oxide.

21. The process to manufacture an integrated photonic resonator circuit according to claim 14, wherein said heater element is positioned over or under said resonator, and said sensor element is positioned over said heater.

22. The process to manufacture an integrated photonic resonator circuit according to claim 21, wherein said heater element and said sensor element are put down and patterned in separate steps.

23. The process to manufacture an integrated photonic resonator circuit according to claim 22, wherein said heater element and said sensor element are manufactured from different materials.
